(19) United States
(12) Patent Application Publication
(10) Pub. No.: US 2004/0076555 A1
(43) Pub. Date: Apr. 22, 2004

(54) Shaft reactor comprising a gassed discharge cone

(76) Inventor: Viktor Wagner, Flawil (CH)

Correspondence Address: BACHMAN & LAPOINTE, P.C., 900 CHAPEL STREET, SUITE 1201, NEW HAVEN, CT, 06510, US

(21) Appl. No.: 10/415,799

(22) PCT Filed: Jul. 4, 2001
(86) PCT No.: PCT/CH01/00418

(30) Foreign Application Priority Data
Nov. 2, 2000 (DE) 100 54 240.9

(51) Int. Cl. B01J 8/12

(52) U.S. Cl. 422/139; 422/131; 422/190

(57) ABSTRACT

The invention relates to a device for thermally treating or post-treating synthetic material, especially polyester material such as polyethylene terephthalate (PET). The gassing of the granulate (8) primarily takes place in the conical discharge area (5) of the shaft reactor. To this end, a middle cylindrical partial area (5b) is situated in the conical discharge area (5) between an upper conical partial area (5a) and a lower conical partial area (5c). Said middle cylindrical partial area has a cylinder jacket-shaped slotted hole screen (10) whose slots run parallel to the axis of the discharge area (5) in a vertical manner. The invention is characterized in that the bulk of the granulate (8) located in the discharge area (5) is gassed. In addition, the friction between the downwardly moving granulate (8) and the gassing area (7) formed by the slotted hole screen (10) is minimized.

The present invention relates to a device for thermally treating or post-treating synthetic material, in particular polyester material such as polyethylene terephthalate (PET), in accordance with the preamble of claim 1.

Shaft reactors for thermal post-treatment, for solid phase polymerisation of synthetic granulate in particular, are known. They typically comprise an upper cylindrical area and a lower area tapering to the discharge of the shaft.

A class of polymer synthetics important for many applications is polyesters, for example polyethylene terephthalate (PET), in particular. In thermal post-treatment the granulates of the synthetic material are generally crystallised first at least on their surface, so that with further treatment serving predominantly to increase the degree of polymerisation the grains are less inclined to adhere than would be the case with the starting granulate of amorphous polyester grains.

(Pre)crystallisation is typically performed in fluidised bed reactors, while subsequent (post)polymerisation takes place in the solid phase and additional crystallisation of the granulates takes place in a shaft reactor. The aim of this treatment is to increase the intrinsic viscosity of the polymer via the increasing degree of polymerisation.

With polymerisation by esterification for each ester bond a water molecule is released which must be taken from the esterification equilibrium, to prevent the formed ester bonds from splitting again.

In the article “choosing purge vessels for mass transfer”, Dale J. Herron, Chemical Engineering, Dec. 7, 1987, page 107, various gassing options are introduced for only gassing the upper, cylindrical section of the shaft reactor, or additionally gassing the conical outlet area underneath the cylindrical section. The conical outlet is here gassed via a perforation in the conical surface of the outlet (“hole cone”). It is here also evident that one must either refrain from gassing the conical outlet, or accept the additional friction resulting from the perforated conical surface, with the negative consequences mentioned above.

NL-A-7 006 398 describes a dryer or shaft reactor for drying or gassing a grainy product. This dryer or shaft reactor has an essentially conical outlet area from an upper conical partial area, a middle cylindrical partial area and a lower conical partial area, which are adjacent to each other, wherein the middle cylindrical area has a gassing area for gassing the granulate. The outlet area of the dryer or shaft reactor is interspersed by a vertical conveyor coil extending along the reactor axis, through which the grainy product can be upwardly conveyed from the lower conical partial area into the upper conical partial area of the outlet area. The vertical transport coil forming an “active” component of the dryer or shaft reactor makes this device relatively expensive for the thermal treatment of a grainy material.

FR-A-918 528 describes a device for gassing a grainy material, whose outlet area also exhibits an upper conical partial area, a middle cylindrical area and a lower conical partial area, which are adjacent to each other, wherein the middle cylindrical partial area has devices for gassing the granulate. These gassing devices consist of lattices that extend horizontally, i.e. perpendicular to the vertical flowing direction of the granulate, and are intended to enable as uniform a gassing of the grainy product as possible over its entire cross section. However, these horizontal gassing lattices generate a uniform resistance over the entire cross-sectional area of the device, and so do not help to make the flow rate of the granulate more uniform. For this reason, additional conical displacers with an upwardly projecting tip are required inside the device.

U.S. Pat. No. 4,540,547 also describes a shaft reactor whose outlet area has an upper conical partial area, a middle cylindrical partial area and a lower conical partial area. Gassing here also takes place in the middle cylindrical partial area for the catalytic treatment of hydrocarbons. However, no measures have been taken to prevent an elevated flow rate of the grainy material in the axial area of the reactor (so called “core flow”).

The object of this invention is to achieve as uniform a gassing as possible in the entire shaft volume, but above all in the conical outlet area, in a shaft reactor for the thermal post-treatment of polyester granulate, for example, without having to greatly decelerate the granulate at the interior shaft walls of the gassing areas and deal with a high flow rate of the granulate in the middle of the reactor, along with the mentioned disadvantages.

The object is achieved via the characterizing features of claim 1.

As the result of dividing the downwardly tapering outlet area into an upper conical partial area, a middle cylindrical partial area and a lower conical partial area as provided and gassing through the middle cylindrical partial section, and of executing the cylindrically symmetrical, central built-in unit concentric to the shaft axis designed as a hollow displacer body having an upper, downwardly tapering partial area and a lower partial area, the friction between the vertical interior wall of the cylindrical gassing area and the granulate is greatly reduced, since the normal force of the granulate mass on the cylindrical interior wall is less than on the conical interior wall, and the flow of granulate is slowed in its middle area, thereby diminishing the “core flow”, i.e., preventing a reduced retention time in the middle area owing to the irregular velocity profile of the granulate.

In a particularly preferred embodiment, the additional gassing area consists of a bar sieve resembling a cylindrical jacket, whose gaps run parallel to the cylindrical axis A of the bar sieve. The vertical alignment of the gap reduces the friction between the granulate and the interior wall of the gassing area formed by the bar sieve even further.

The bar sieve resembling a cylindrical jacket is best enveloped by a casing that also resembles a cylindrical jacket and is arranged concentric to the bar sieve, making it possible to uniformly gas over the entire circumference of the cylindrical gassing area.

The central built-in unit is preferably a displacer having an upper partial area and a lower partial area. In particular, the lower partial area and the upper partial area of the displacer have at least one opening, and the lower area with its at least one opening is here situated at about the same height as the upper edge of the bar sieve. This enables a portion of the gas supplied through the bar sieve in the gassing area to get through the lower opening and inside the displacer, and move through the hollow displacer up to its upper opening, where it is again released into the granulate, but not radially from outside this time, as in the area of the bar sieve, but radially from the inside out. This helps to make the gassing of the granulate more uniform.

As an alternative, the displacer can also be closed and/or situated further below, so that its tip is at about the height of the upper edge of the cylindrical bar sieve.

It is particularly expedient for the cylindrical partial area to consist of several cylindrical jacket sections, i.e., that the bar sieve be comprised of cylindrical jacket halves, for example. This permits an easy assembly and disassembly of the bar sieve for cleaning and maintenance activities at the outlet cone.

Further advantages, features and application options of the present invention will emerge from the following description of the prior art, and of the non-limiting preferred embodiments of the invention with reference to the attached diagram, in which:

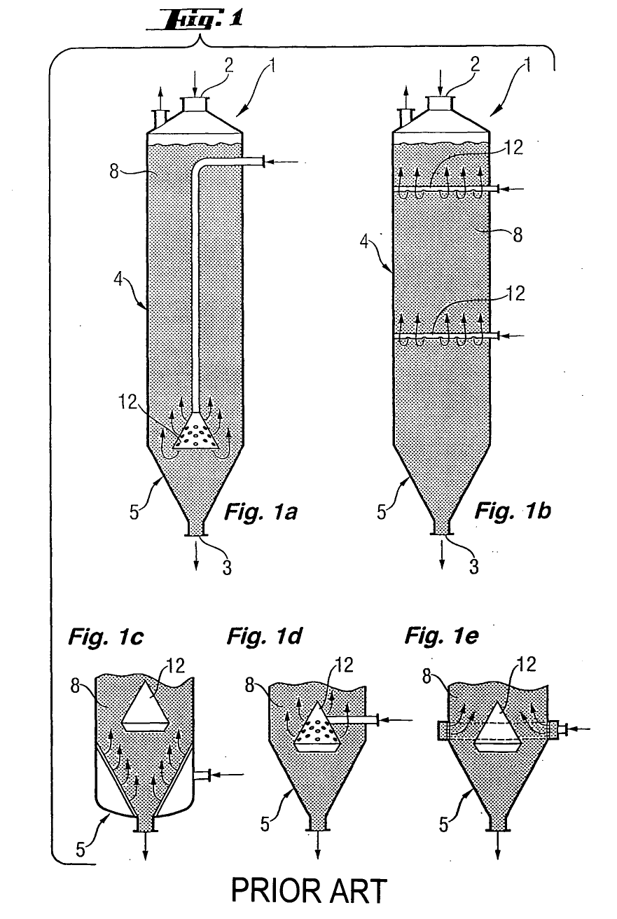

FIG. 1 illustrates different variants of the prior art for gassing shaft reactors;

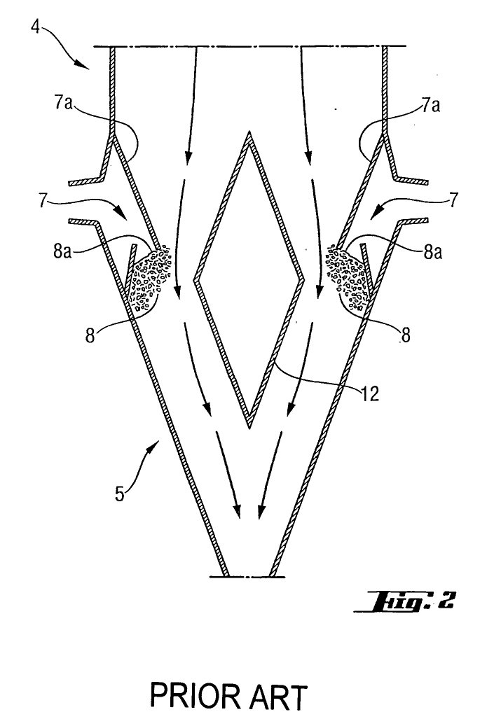

FIG. 2 illustrates another variant of the prior art for gassing the discharge areas of a shaft reactor;

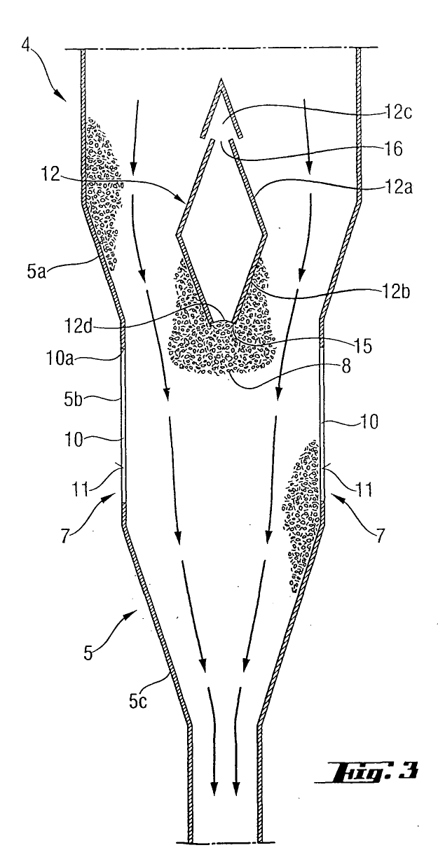

FIG. 3 illustrates in a diagrammatic sectional view a first embodiment of the present invention for gassing the discharge area of a shaft reactor;

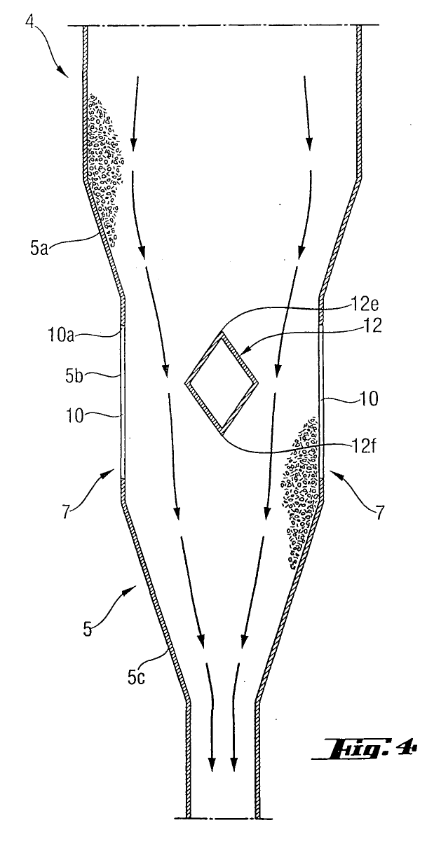

FIG. 4 illustrates in a diagrammatic sectional view a second embodiment of the present invention for gassing the discharge area of a shaft reactor,

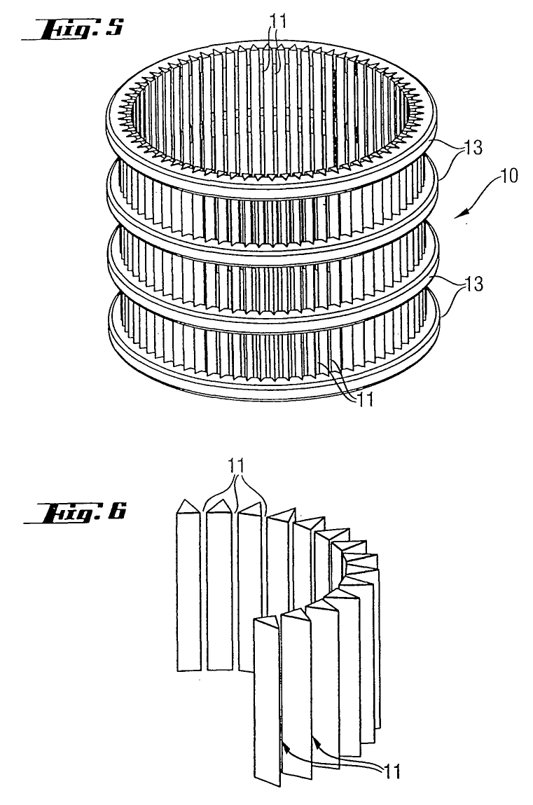

FIG. 5 illustrates a perspective view of an element of the embodiments according to the present invention of FIGS. 3 and 4; and

FIG. 6 illustrates a diagrammatic perspective view of a partial area of the element of FIG. 5.

FIG. 1 illustrates several typical shaft reactors 1 of the prior art. FIG. 1a illustrates a shaft reactor 1 whose granulate 8 fills out the upper cylindrical area 4 as well as the conical discharge area 5 of the reactor. The gassing takes place via an internal fitting 12 at the lower end of the cylindrical area 4 or above the conical discharge area 5 of the shaft 1.

FIG. 1b illustrates a similar shaft 1, whose granulate 8 follows via internal fittings 12 in the upper cylindrical area 4 of the shaft, whereby in each case the internal fittings 12 extend in a horizontal plane inside the shaft. FIGS. 1c, 1d, and 1e each slow the conical discharge area 5 of a shaft, whereby in each case a conical internal fitting 12 is provided above or at the upper end of the conical discharge area 5. This fitting 12 on the one hand serves to standardise the granulate rate profile in the shaft reactor 1 (FIGS 1c, 1d and 1e), and on the other hand serves to gas the shaft reactor (FIG. 1d). In FIG. 1c gassing of the shaft reactor takes place via the conical jacket of the conical discharge area 5. In variants a, b and d of FIG. 1 only that part of the granulate 8 is gassed which is located above the internal fittings 12. In all these cases there is no gassing of the discharge area 5. Only variant c of FIG. 1 gases the entire granulate 8 of the shaft 1. In this variant c, as for variants a and d of FIG. 1, increased friction between the downwards moving granulate 8 and each oblique conical gassing surface must be reckoned with. This leads to the abovementioned broadening of the holding time range of the granulate and in the worst case to clumping of granulates on the gassing surface.

FIG. 2 illustrates another variant for gassing a shaft reactor under its cylindrical area 4. Located inside the discharge areas 5 is an internal fitting 12 which is here designed as a double cone (“diamond”). The gassing area 7 extends in a peripheral direction around the upper part of the discharge area 5. The granulate flow, indicated by both continuous arrows, moves from the upper cylindrical area 4 of the shaft reactor downwards and flows through a narrow waist created by the upper part of the double cone 12 and a conical baffle plate 7a. Behind the lower edge of the baffle plate 7a the granulate 8 forms an angle of repose 8a which is subjected to the gas streaming in through the gassing area 7. A drawback to this gassing of the conical discharge area 5 is that only a very small surface of the granulate 8 is exposed to gassing. Only the cone jacket surface formed by the angle of repose 8a of the granulate 8 is made available for gassing.

FIG. 3 illustrates a first preferred embodiment of the gassed discharge area 5 according to the present invention of a shaft reactor. The granulate 8 moves downwards from the upper cylindrical area 4 in the direction indicated by the continuous arrows, whereby it moves around the middle internal fitting 12 and migrates via an upper conical partial area 5a of the discharge area 5 to a middle cylindrical partial area 5b and finally to a lower conical partial area 5c of the discharge areas 5. The middle cylindrical partial area 5b contains a cylinder jacket-shaped hole screen 10 which forms the gassing area 7. The drying gas (for example air or preferably pure nitrogen) flows through the hole screen 10 radially inwards from outside into the middle cylindrical partial area 5b and moves upwards against the granulate flow. A portion of the gas flowing upwards through the granulate reaches the interior of the internal fitting 12 via the granulate surface 12d through an opening 15 at the lower end of the internal fitting 12, to finally return to the granulate flow via an upper opening 16 of the internal fitting 12, which is covered by hood 12c pointed at the top. But this time the gas moves radially outwards from the inside, contributing to standardising of the gassing.

In contrast to the prior art there are no perforations or any gassing slots on non-vertical surfaces of the shaft reactor. Gassing occurs only in the gassing area 7, formed by slots 17 arranged vertically and cylinder jacket-shaped. Since the slots 11 (see FIG. 5) are all arranged perpendicularly, any friction between the granulate and the gassing area 7 is minimised.

FIG. 4 illustrates a second preferred embodiment of the gassed discharge area 5 of a shaft reactor according to the present invention. The outer sheath of the discharge area 5 is designed just like that in the first embodiment, i.e. it comprises an upper conical partial area 5a, a middle cylindrical partial area 5b, essentially consisting of the hole screen 10, and a lower conical partial area 5c. In this second embodiment the middle internal fitting 12 acting as displacer is a closed hollow body in the form of a double cone or octahedron (“diamond”), sharp at the top and bottom. Preferably it is arranged at such a height inside the shaft discharge 5 that its upper peak 12e is situated approximately at the same height as the upper edge 10a of the hole screen 10.

Effectively enclosing the cylinder jacket-shaped hole screen 10 is a likewise cylinder jacket-shaped housing (not shown) arranged concentrically to the hole screen 10, to achieve even distribution of the gas in the gassing area 7.

FIG. 5 is a perspective view of the hole screen 10 in the shaft reactor according to the present invention. The cylinder is made from screens which are rolled into a cylinder and welded at the butt seam. The smooth profile surface faces inwards (see FIG. 5), whereas the pointed side of the profile faces outwards. The support profiles 13 lie outside as rings on the lattice.

FIG. 6 illustrates a section of the cylindrical hole screen of FIG. 5. The individual hole screen rods 11 lie with their smooth face inwards, while their sharp side faces outwards. This configuration is suitable for a gas flow from outside inwards and enables a lateral gassing facing radially inwards, whereby at the same time the resistance for the gas flowing in between the hollow screen rods 11 and the resistance for the granulate sliding along the smooth surfaces of the hollow screen rods 11 is minimised.

It is acknowledged that within the scope of the present invention the gassing surfaces lie predominantly in vertically disposed areas of the walls of the shaft discharge.

Neither is the invention limited to the two embodiments described and illustrated hereinabove. So a discharge geometry is conceivable for example, wherein not only a cylindrical gassing area 5b is arranged between conical partial areas 5a, 5c, but also several cylindrical gassing areas are integrated in the predominantly conical discharge area 5. A typical arrangement for example would be from top to bottom successively and with increasing diameter: conical, cylindrical with gassing, conical, cylindrical with gassing, conical.

Legend

| | |
|---|---|
| 1 | shaft/shaft reactor |
| 2 | fill opening |
| 3 | discharge opening |
| 4 | cylindrical area |
| 5 | discharge area |
| 5a | upper conical partial area |
| 5b | middle cylindrical partial area |
| 5c | lower conical partial area |
| 6 | gassing area |
| 7 | gassing area |
| 7a | baffle plate of the gassing area |
| 8 | granulate |
| | talus cone of the granulate |
| 10 | hole screen |
| | upper edge of the hole screen |
| 11 | hole screen rod |
| 12 | middle internal fitting |
| | upper partial area of the internal fitting |
| | lower partial area of the internal fitting |
| 12c | hood |
| | granulate surface |
| | upper peak |
| 12f | lower peak |
| 13 | support profile |
| 15 | lower opening |
| 16 | upper opening |

1. A device for thermal treatment or post-treatment of synthetic material, in particular polyester material such as polyethylene terephthalate (PET), with a vertical shaft (1), which has an upper fill opening (2) and a lower discharge opening (3) and in which the granulate is fed from top to bottom in a vertical direction, whereby the shaft (1) has an upper cylindrical area (4) as well as a lower conical discharge area (5) attached thereto and tapering downwards, characterised in that the substantially conical discharge area (5) comprises an upper conical partial area (5a), a middle cylindrical partial area (5b) and a lower conical partial area (5c), which abut one another, whereby the middle cylindrical partial area (5b) forms an additional gassing area (7) for gassing of the granulate.

2. The device as claimed in claim 1, characterised in that the additional gassing area (7) comprises a cylindrical jacket-shaped hole screen (10), whose slots run parallel to the cylinder axis of the hole screen.

3. The device as claimed in claim 2, characterised in that the cylinder jacket-shaped hole screen (10) is enclosed by a likewise cylinder jacket-shaped housing arranged concentrically to the hole screen.

4. The device as claimed in any one of the foregoing claims, characterised in that in the discharge area (5) a cylindrical symmetrical middle internal fitting (12) is provided, arranged concentrically to the shaft axis.

5. The device as claimed in claim 4, characterised in that the middle internal fitting (12) is a hollow displacer, which has an upper partial area (12a) tapering upwards and a lower partial area (12b).

6. The device as claimed in claim 5, characterised in that the displacer (12) in its lower partial area (12b) and in its upper partial area (12a) has in each case at least one opening (15 or 16), and whereby the lower partial area (12b) with its at least one opening (15) is on approximately the same level as the upper edge (10a) of the hole screen (10).

7. The device as claimed in any one of claims 1 to 3, characterised in that a middle internal fitting (12) is provided as displacer in the form of a double cone or a polyhedron, wherein one peak (12e) points upwards and one peak (12f) points downwards.

8. The device as claimed in claim 7, characterised in that the displacer (12) is hollow inside and has no openings.

9. The device as claimed in claim 8, characterised in that the upper tip (12e) of the displacer (12) is located approximately at the same level as the upper edge (10a) of the hole screen (10).

10. The device as claimed in any one of the foregoing claims, characterised in that in its upper area (4) it contains another gassing area (6) for gassing the granulate.

11. The device as claimed in any one of the foregoing claims, characterised in that the conical discharge area (5) comprises several conical and cylindrical partial areas alternating successively from top to bottom and arranged successively, with a diameter increasing from top to bottom.

12. The device as claimed in any one of the foregoing claims, characterised in that additional internal fittings are arranged inside the upper area (4).

13. The device as claimed in claim 12, characterised in that the internal fittings of the upper area (4) are designed roof-shaped, whereby the ridge or the peak of the roof-shaped internal fittings points upwards.
